(19) United States
(12) Patent Application Publication
(10) Pub. No.: US 2026/0194141 A1
(43) Pub. Date: Jul. 9, 2026

(54) SEAL

(71) Applicant: SERVICE IMPEX COSTA DORADA S.L., Salou Tarragona (ES)

(72) Inventor: Alexandru CERBARI, Salou Tarragona (ES)

(21) Appl. No.: 19/132,133

(22) PCT Filed: Oct. 16, 2023
(86) PCT No.: PCT/EP2023/078636

§ 371 Date: May 22, 2025

(30) Foreign Application Priority Data
Nov. 24, 2022 (DE) 10 2022 131 164.3

(51) Int. Cl. F16J 15/06

(52) U.S. Cl. CPC F16J 15/06

(57) ABSTRACT

It relates to a seal (01) with a seal body (02) and a seal band (03), wherein the seal body (02) comprises a seal jacket (06) with two seal jacket halves (61, 62) movably connected to each other along a connecting flap (60) in an initial state, and a seal core (05). The seal jacket halves (61, 62) can be irreversibly sealably connected at least to each other to transfer to an operational state. At least one of the seal jacket halves (61, 62) is provided with an adhesive layer intended to create the seal.

The invention relates to a seal according to the preamble of claim 1.

A seal consists of a seal body and a seal band. To withstand even ex-treme weather conditions, it is made of weather-resistant material. Nowadays, this is typically metal or plastic.

When sealing, the seal band is laid in a curve to form a bay. The seal band is passed through two opposite openings on elements that move away from each other when opening or operating.

The opposite openings are, for example, part of a closure. After the bay has been formed in this way, the seal band is then fixed into a loop using the seal body.

In this document, the term loop refers to a fixed eye in rope and/or webbing. The fixed eye does not come loose and does not tighten.

The loop is dimensioned in such a way that it must be irreversibly de-stroyed in order to be removed. The loop must be removed, for example, to gain access to a container's contents or to a device, or to change a setting.

Sealing thus provides evidence of whether a setting is unmanipulated, a container has remained closed, or a device has remained unused.

Because a seal can only be removed by destruction, in the best case it contributes to waste generation. In the worst case, it spontaneously enters the environment. Both are detrimental to environmental protection.

DE 295 06 104 U1 discloses a seal made of cardboard material. The seal body and seal band are one-piece. The seal band extends from the seal body. The seal body consists of two parts that can be folded onto each other. The two parts can be folded onto each other around a fold line running parallel or perpendicular to the seal band. The two parts are provided with an adhesive layer. In an operational state of the seal, the seal body can be irreversibly sealed with a portion of the seal band spaced apart from it. Here, the portion of the seal band remote from the seal body is passed through and glued between the two parts of the seal body.

CH 170 891 A discloses an advertising seal. This consists of a seal body and an advertising mark. The seal body connects seal band portions entering and exiting it. The advertising mark frames the seal body. The advertising mark covers the seal band portions entering and exiting the seal body. The advertising mark can only be detached from the seal body after the seal has been released.

WO 2020/157345 A1 discloses a security label comprising a security band. The security band has irremovably interconnectable end pieces at its two distal ends. The two end pieces are designed as male and female types. The security band consists of cellulose or a derivative thereof. The end pieces are made of biodegradable plastic.

US 2004/032332 A1 discloses a seal in the form of a cable tie made of biodegradable material. The seal is designed with a seal body and a seal band with a male and female type fastening. The seal band is fixed on one side to the seal body.

An information carrier can be incorporated into the seal band or the seal body. The information contained therein can be read out contactlessly.

U.S. Pat. No. 2,639,479 discloses an adhesive seal. The adhesive seal consists of a bottom flap, a top flap, and a security band. The bottom flap is provided with a through-opening for the ends of the security band. The top flap is hingedly connected to the bottom flap. The through-opening can be designed as a slot worked in from the edge of the bottom flap, or as a central hole. A band, such as a package or gift rib-bon, is placed with its free ends through the through-opening. By folding the top flap onto the bottom flap, the two portions of the band that have come to lie between the two flaps are fixed by the adhesive layer arranged on the side of the bottom flap facing the top flap. By means of the adhesive layer arranged on the side of the bottom flap facing away from the top flap, the adhesive seal together with the band is fixed to the package or gift by gluing.

An object of the invention is to create a preferably environmentally friendly seal that is simple to handle and provides improved protection against sub-sequent alteration.

The object is solved by the features of the independent claim. Advantageous embodiments are reproduced in the claims, the drawings, and the following description, including those relating to the drawings.

The invention is explained in more detail below with reference to exemplary embodiments shown in the drawing. Additional advantages over the prior art that go beyond the complete solution of the posed task are also listed. The size relationships of the individual elements to each other in the figures do not always corre-spond to the real size relationships, as some forms are simplified and other forms are enlarged in relation to other elements for better illustration. Identical reference signs are used for identical or identically acting elements of the invention. Furthermore, for the sake of clarity, only reference signs that are necessary for the description of the respective figure are shown in the individual figures. The illustrated embodiments merely represent examples of how the invention can be designed and do not represent a conclusive limitation. The schematic representations show:

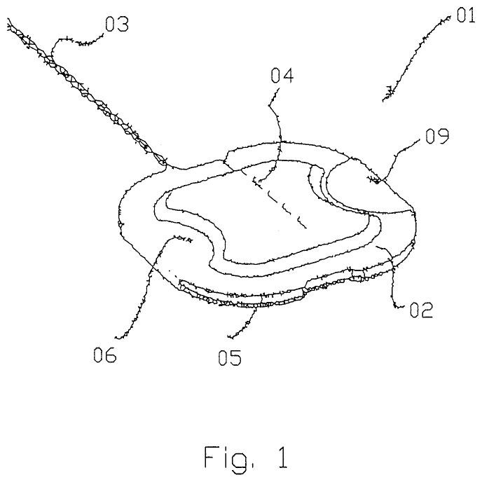

FIG. 1—a perspective view of a seal 01 comprising a seal band 03 and a seal body 02 with a seal core 05 and a seal jacket 06 housing it in its operational state.

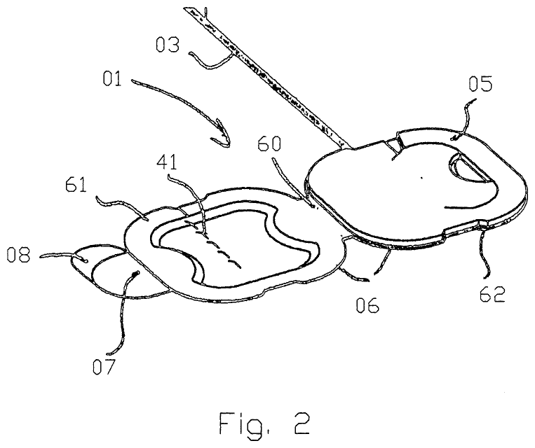

FIG. 2—a perspective view of the seal 01 from FIG. 1 in its initial state.

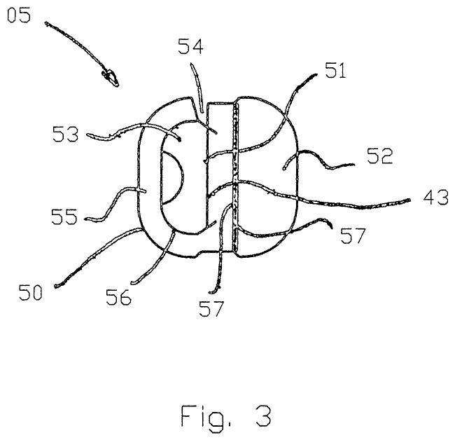

FIG. 3—a top view of the seal core 05 of the seal 01 from FIG. 1.

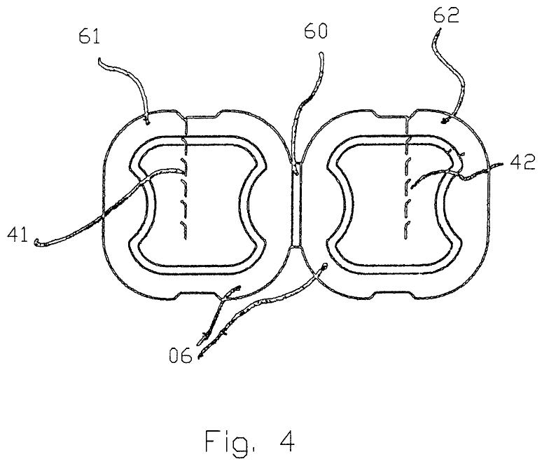

FIG. 4—a top view of the seal jacket 06 in the initial state of the seal 01 from FIG. 1.

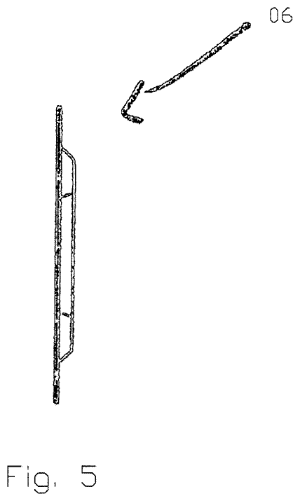

FIG. 5—a side view of the seal jacket 06 in the initial state of the seal 01 from FIG. 1.

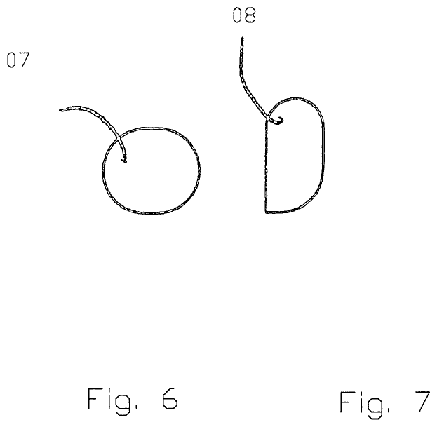

FIG. 6—a top view of a security flap of the seal 01 from FIG. 1, also referred to as a security label 07.

FIG. 7—a top view of a flap protector of the seal 01 from FIG. 1, also referred to as a label protector 08, which is to be removed to transfer the seal 01 from the initial state (FIG. 2) to the operational state (FIG. 1).

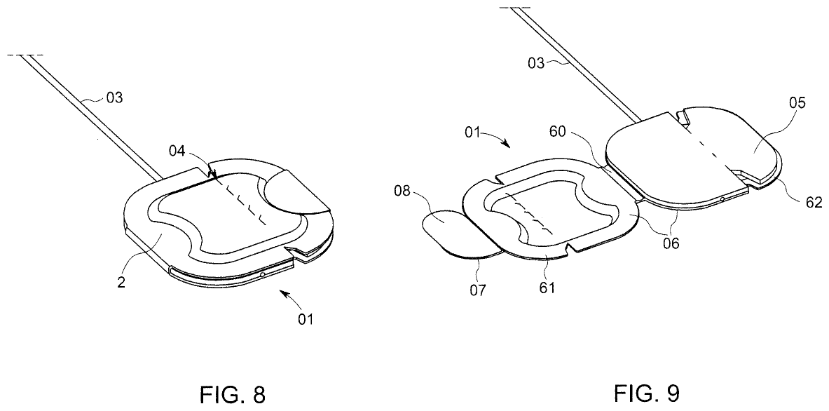

FIG. 8—a perspective view of a seal 01 comprising a seal band 03 and a seal body 02 with a seal core 05 and a seal jacket 06 housing it, in a design different from FIG. 1 to FIG. 7, in its operational state.

FIG. 9—a perspective view of the seal 01 from FIG. 8 in its initial state.

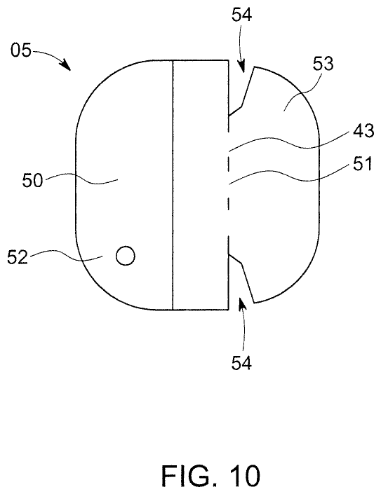

FIG. 10—a top view of the seal core 05 of the seal 01 from FIG. 8.

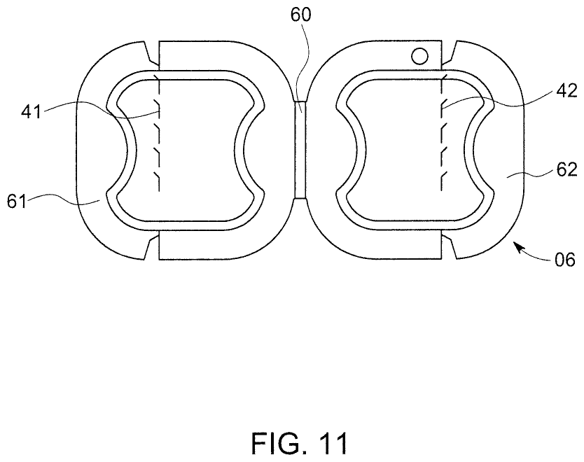

FIG. 11—a top view of the seal jacket 06 in the initial state of the seal 01 from FIG. 8.

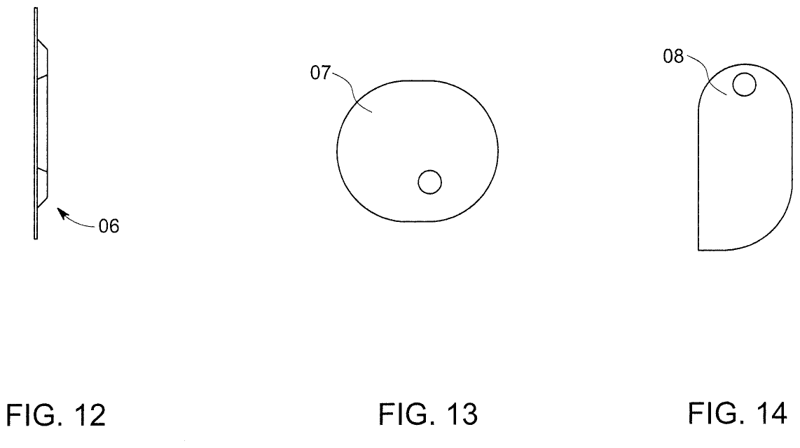

FIG. 12—a side view of the seal jacket 06 in the initial state of the seal 01 from FIG. 8.

FIG. 13—a top view of a security flap of the seal 01 from FIG. 8, also referred to as a security label 07.

FIG. 14—a top view of a flap protector of the seal 01 from FIG. 8, also referred to as a label protector 08, which is to be removed to transfer the seal 01 from the initial state (FIG. 9) to the operational state (FIG. 8).

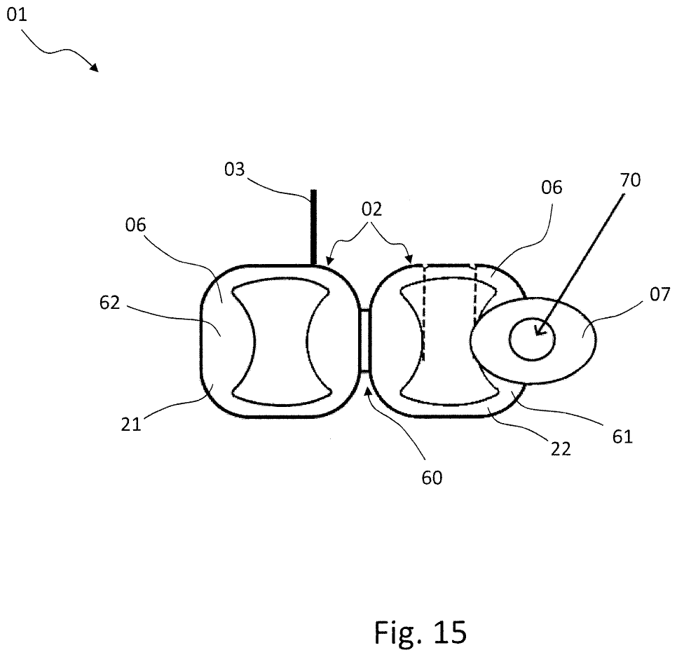

FIG. 15—a perspective view of another design of a seal 01 comprising a seal band 03 and a seal body 02 with a seal core 05 and a seal jacket 06 housing it, different from the designs shown in FIG. 1 to FIG. 7 and in FIGS. 8 to 14, in its initial state, looking at the outer sides of the halves 61, 62 of the seal jacket 06, which are also each include-ed in a portion 21, 22 of the seal body 02, preferably integrally movably connected to each other by a connecting flap 60 provided, for example, with a fold line.

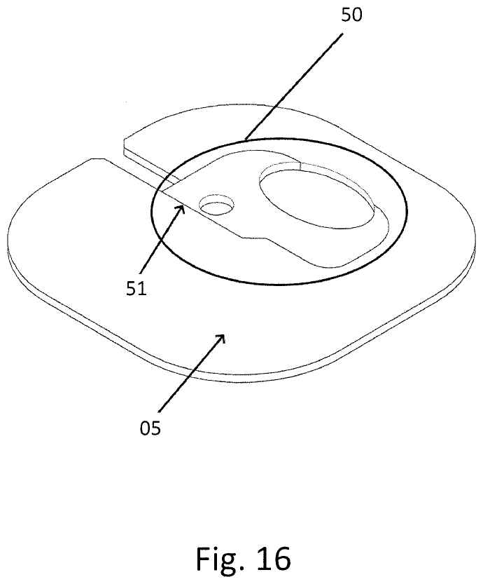

FIG. 16—a perspective view of the seal core 05 of the seal 01 from FIG. 15, designed as a plate 55 with a securing element connected to it along a fold line 51, which is arranged in an area within a circular marking 50 highlighted in the drawing. The plate comprising the securing element connected to it along the fold line 51, also referred to as a crease line, has a semi-oval opening which forms a protrusion on the securing element representing a locking part. A hole is formed on the securing element. The plate is provided with a slot leading to an edge of the plate. To close the seal 01, the upper free end of the flexible closure element, for example formed by a rope, briefly referred to as the seal band 03, is inserted into the hole in the locking part, whereby it is advantageous to minimize the loop in the eyelets of the object to be sealed. Furthermore, the free end of the flexible closure element formed by a rope, briefly referred to as the seal band 03, wraps around the protrusion of the locking part from below and enters the slot of this element, thereby wrapping the rope around the rigid protrusion and forming a loop.

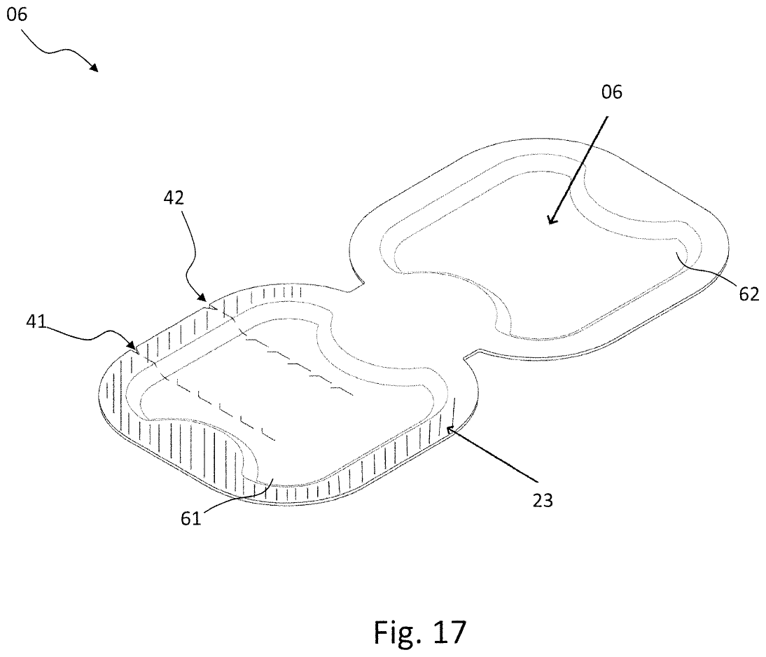

FIG. 17—a perspective view of the seal jacket 06 in the initial state of the seal 01 from FIG. 15, provided with, for example, two perforation lines 41, 42 as predetermined breaking points in, for example, one half 61 of its two halves 61, 62, whereby at least one half 61, 62 of the seal jacket 06 is provided with an adhesive layer 23 or with a part of an adhesive layer 23.

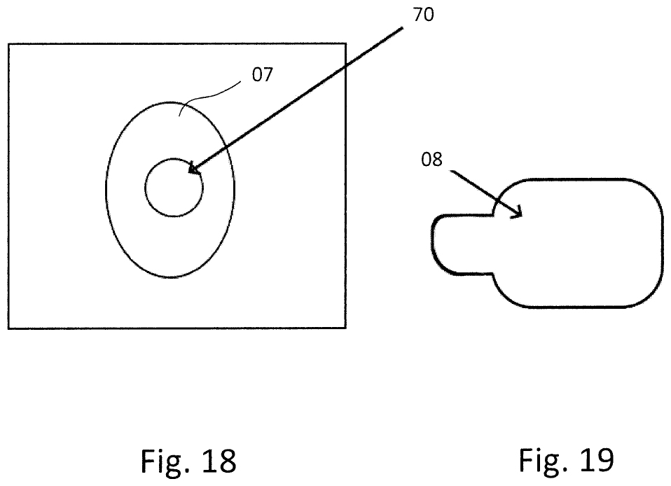

FIG. 18—a top view of a security flap of the seal 01 from FIG. 15, also referred to as a security label 07, arranged on a carrier substrate. The security label 07, also referred to as a closure sticker, can be provided with an indicator 70 for detecting at least one environmental influence, which for example indicates thermal stress, ionizations, ra-dioactivity in their maximum intensity and/or cumulatively over time.

FIG. 19—a top view of a flap protector of the seal 01 from FIG. 15, also referred to as a label protector 08, which is to be removed to transfer the seal 01 from the initial state (FIG. 15) to an operational state, designed for example as a special film or comprising such a film.

A seal 01 shown in whole or in part in FIG. 1, FIG. 2, FIG. 3, FIG. 4, FIG. 5, FIG. 6, FIG. 7 comprises a seal body 02 and a flexible closure element in the form of a seal band 03 that can be laid into a loop on the seal body 02 and can be irreversibly connected to the seal body 02 at least without destruction to maintain a seal.

The seal 01 has an initial state and an operational state.

The seal body 02 comprises a seal core 05 and a seal jacket 06 with two seal jacket halves 61, 62 movably connected to each other along a connecting flap 60 in an initial state.

The seal jacket halves 61, 62 can be irreversibly sealably connected to each other as well as advantageously to at least one, preferably two spaced-apart sections of the seal band 03 to transfer to the operational state.

At least one of the seal jacket halves 61, 62 is provided with an adhesive layer to create the seal formed by an irreversibly sealable connection of the two seal jacket halves 61, 62 with the remaining seal jacket half 62, 61. The adhesive layer can also serve or at least contribute to fixing one or more sections of the seal band 03 if necessary.

In the initial state, the adhesive layer can be protected by a special film before sealing.

In the initial state, one seal jacket half 61, 62 of the seal body 02 is provided with the seal core 05. In the operational state, the seal core 05 is housed between the irreversibly sealed connected seal jacket halves 61, 62 of the seal body 02.

In the operational state, the seal band 03 is fixed along two spaced-apart sections between the seal jacket halves 61, 62 of the seal body 02. A part of the seal band 03 running outside the seal body 02, remaining between fixed sections on both sides, is fixed into a loop in the operational state.

Preferably, in the initial state, a first section of the seal band 03 is fixed on or in the seal body 02. For example, a first section of the seal band 03 is fixed at least partially between the seal core 05 and the seal jacket half 61, 62 of the seal body 02 provided with it.

The seal core 05 has a securing element 50 for fixing at least one second section of the seal band 03.

The securing element 50 of the seal core 05 has an anchor part 53 pivotally connected to a base part 52 along a core fold line, briefly referred to as fold line 51 and also as core fold line or core bend line, in the initial state. The fold line 51 can be formed by a crease, for example.

Advantageously, in the operational state, at least the second section of the seal band 03 is wrapped at least once around the anchor part 53.

Preferably, the section of the seal band 03 to be fixed to create the operational state wraps around the anchor part 53 at least partially parallel to the core fold line.

The seal is characterized in that the anchor part 53 of the securing element 50 is surrounded on multiple sides by a remaining seal core part 55 of the seal core 50, of which remaining seal core part 55, however, only a part is connected to the anchor part 53 via the fold line 51.

A remaining part of the seal core 05 spans a plane, within which plane the anchor part 53 borders the remaining part of the seal core 05 on multiple sides, even being completely or partially surrounded by it. For example, the remaining seal core part 55 borders the anchor part 53 on two or more sides. Advantageously, the remaining seal core part 55 can form a frame completely or partially surrounding the anchor part 53.

Preferably, in the initial state, at least the remaining seal core part 55, preferably alternatively or additionally the base part 51, is connected to a seal jacket half 62, preferably glued.

Particularly preferably, the fold line 51 is realized by a half-cut 43. The half-cut 43 can be realized, for example, by either not completely cutting through a cardboard plate, but only partially, especially in relation to its thickness or strength, or by gluing two cardboard plates together, whereby one cardboard plate is cut through in the area of the half-cut 43 and the remaining cardboard plate is formed continu-ously across the half-cut 43.

Alternatively to a half-cut 43, the fold line 51 can be realized, for example, by a perforation line or a crease, or by a combination.

The anchor part 53 borders the fold line 51 on one side. The anchor part 53 is separated from the remaining seal core part 55 on its other sides, for example, by a separation line 56 produced by punching.

Towards the fold line 51, the separation line 56 preferably converges in a V-shape. This causes the seal band 03 to lie closely along the fold line 51 when at least partially wrapping around the anchor part 53. The separation line 56 can run across the fold line 51 on one or both sides, as shown in FIG. 3.

A notch 54 can be provided adjacent to the fold line 51. Preferably, such a notch 54 is provided along a section around the anchor part 53.

The fold line 51 can be formed, for example, by a crease.

The separation line 56 can be produced by punching. A notch 54, if provided, can be produced simultaneously with the separation line 56 by punching.

Advantageously, the anchor part 53 of the securing element 50 is connected to the remaining seal core part 55 and thus to the entire remaining part of the seal core 05 via the fold line 51. On sides that may not border the fold line 51, there is preferably no connection between the anchor part 53 and the remaining seal core part 55. The separation line 56 runs along at least part of this separation.

The anchor part 53 is advantageously surrounded frame-like by the remaining seal core part 55.

The anchor part 53 is preferably connected on one side to the remaining seal core part 55—preferably the frame—via the fold line 51. On the remaining sides, the connection between the anchor part 53 and the frame is interrupted, for example by punching. A notch 54 can interrupt the frame's circumference around the anchor part 53.

At least in the initial state, the remaining seal core part 55—preferably the frame—is fixed to a seal jacket half 62, for example by an adhesive layer. In contrast, the anchor part 53 remains pivotable out of the plane spanned by the frame around the fold line 51 in the initial state.

The seal body 02 can be provided with predetermined breaking points 04 that indicate an attempt to detach the seal band 03 from the seal body 02, especially from the securing element 50, by tearing.

The predetermined breaking points 04 can be realized by or comprise one or more perforation lines 41, 42 in the seal jacket 06. Preferably, such a perforation line 41, 42 extends along the extension of the course of the section of the seal band 03 wrapped around the anchor part of the securing element 50 to create the operational state, coming from the loop to the edge of the seal body 02 and beyond it, for example to the center of the seal body 02, at least through the seal jacket 06.

Advantageously, the perforation lines 41, 42 are arranged mirror-symmetrically to the connecting flap 60 on the two seal jacket halves 61, 62. The fold line 51 can also be arranged—at least in the operational state-congruently with these perforation lines 41, 42. A continuous perforation thus runs as a predetermined breaking point 04 along a line through all parts of the seal 01. Along this line, the seal body 02 including the seal core 05 is torn when opening the seal 01. This makes opening the seal 01 simple and without great effort and renders it unusable in the future due to the damage to the main elements of the construction.

It should be particularly emphasized that the seal core 05 preferably has a groove 57 in the area of the base part 52. The groove 57 preferably runs parallel to the fold line 51. The groove accommodates a section of the seal band 03 that is already connected to the seal body 02 in the initial state. The seal band 03 is inserted into the groove with its section already connected to the seal body 02 in the initial state. The base part 52 of the seal core 05 faces the seal jacket half 62 with its side provided with the groove 57 and is glued to the seal jacket half 62 with the section of the seal band 03 inserted into the groove 57. In other words, when gluing the right seal jacket half 62 in FIG. 2 and the seal core 05, the seal band 03 with its section already connected to the seal body 02 in the initial state and placed in the groove 57 is directly clamped and glued between the base part 52 of the seal core 05 and the seal jacket half 62.

In doing so, the remaining seal core part 55 and the right seal jacket half 62 are also immediately connected to each other by gluing. Only the anchor part 53 remains initially connected to the seal jacket 06 only via the fold line 51 until the seal is transferred to its operational state.

To transfer to the operational state, the seal band 03 is wrapped preferably one and a half times around the anchor part 53 with a second section that is spaced apart from the first section of the seal band 03 already fixed to the seal body 02 in the initial state.

The second section of the seal band 03 can be or become fixed to the seal body 02, for example, by the following steps:

Folding out the anchor part 53 around the fold line 51 from a plane spanned by the remaining seal core part 55 and the seal jacket half 62 provided with the seal core 05,

At least partially, preferably at least once, wrapping the folded-out anchor part 53 with the section of the seal band 03 to be fixed to the seal core 05 to create the operational state. Preferably, the wrapping is done parallel to the fold line 51.

Folding back the anchor part 53, which is at least partially wrapped by the section of the seal band 03 to be fixed, back into the plane spanned by the remaining seal core part 55 and the seal jacket half 62 provided with the seal core 05, and

Folding together and gluing the two seal jacket halves 61, 62 around the connecting flap 60.

The gluing is preferably done by removing a protective film from at least one of the two seal jacket halves 61, 62. Subsequently, the two seal jacket halves 61, 62 are folded together around the connecting flap 60 in alignment and by overlapping their surfaces to be glued together by means of the adhesive layer, whereby the now unprotected adhesive layer on at least one of the two seal jacket halves 61, 62 faces the respective other seal jacket half 62, 61.

The seal band 03 is wrapped directly around the anchor part 53, preferably in one and a half turns around the anchor part 53. This forms a loop of the seal band 03 that securely holds the seal band 03 to the anchor part 53 when attempting to pull it out of the seal jacket 06 after closing. This simplifies the production of the seal 01 and the creation of its operational state.

The seal body 02 can be provided with at least one indicator for detecting at least one environmental influence.

Such an indicator can be integrated, for example, into a security or safety label 07.

Whether a container content is intact cannot be proven by conventional sealing if the container content can also be changed without opening.

In other words, the integrity of a sealed container content, for example, cannot be proven by a conventional seal if this integrity can be impaired by environmental influences alone, which environmental influences do not require opening the container or direct contact with the container content.

The same applies to sealed settings or sealed devices that can experi-ence changes or impairments solely through environmental influences.

To improve environmental compatibility, at least the seal body 02 and/or the seal band 03 can be made of a biodegradable material.

The seal 01 can be used as described below.

In the initial state, the seal jacket 06 has two halves 61, 62 (seal jacket halves) movably connected to each other by a connecting flap 60.

In the initial state, the seal core 05 is arranged on one of the halves 61, 62, in the example in FIG. 2 the right half 62.

A first section of the seal band 03 can be fixed between the seal core 05 and the corresponding half 61, 62, in the example in FIG. 2 the right half 62.

At least one of the halves 61, 62 can be provided with an adhesive layer. After folding the two halves 61, 62 together, the adhesive layer connects them irreversibly. The adhesive layer can be covered with a removable protective film until the seal 01 is used.

A security label 07, for example self-adhesive, can be arranged on one of the halves 61, 62, in the example in FIG. 2 the left half 61. In the initial state, the security label 07 protrudes laterally beyond the corresponding half 61, 62. The adhesive surface of the security label 07 protruding beyond the corresponding half 61, 62 can be protected by a label protector 08, for example designed as a tear-off film.

To create a seal, the anchor part 53 is first folded up around the fold line 51.

Then the free end of the seal band 03 is passed through eyes or eyelets of an object to be sealed. The second section of the seal band that has now been passed through the eyes or eyelets is advantageously wrapped at least once around the folded-up anchor part 53, passing through a notch 54. The anchor part 53 is then folded back into the plane of the remaining seal core part 55 surrounding it.

The loop of the seal band 03 thus created, passed through the eyes or eyelets of the object to be sealed, is fixed by first removing any protective film arranged on the adhesive layer. Then the remaining seal jacket half 61, 62, in the example in FIG. 2 the left half 61, is folded onto the seal jacket half 62, 61 provided with the seal core 05, in the example in FIG. 2 the right half 62, by bending the connecting flap 60.

The adhesive layer seals the two halves 61, 62 and preferably at the same time the remaining half 61, 62, in the example in FIG. 2 the left half 61, with the seal core 05 while simultaneously fixing the second section of the seal band 03 in the seal body 02.

Now the label protector 08 can be removed from the adhesive surface of the security label 07 protruding beyond the corresponding half 61, 62, in the example in FIG. 2 beyond the left half 61.

The protruding part of the security label 07 is then folded around the edge of the corresponding seal jacket half 61, 62 over which it protrudes and glued onto the other seal jacket half 62, 61.

It is important to emphasize that at least the seal body 02 and/or the seal band 03 can be made of a biodegradable material.

In order to curb the harmful spontaneous release of plastics and metals, which are commonplace for sealing nowadays, into the environment in the spirit of increasing environmental awareness and protection, the seal 01 with seal body 02 and/or seal band 03 made of biodegradable material achieves the goal of minimizing harmful impact on the environment. Such harmful impact on the environment can occur both through spontaneous release of a no longer needed seal 01 into the environment, as well as through proper disposal of a no longer needed seal. It should be noted that spontaneous release cannot be fundamentally prevented. However, due to the biodegradable design of the seal, the release into the environment is not as harmful.

Biodegradable materials, or BAMs for short, must decompose within 6-10 weeks in industrial composting. BAMs are tested according to the DIN standard EN 13432. They do not necessarily have to consist of biological raw materials. Examples include so-called starch blends, for example based on corn, or certain poly-esters.

The biodegradable material can be a biodegradable plastic.

For example, it is a biodegradable and bio-based plastic.

Preferably, however, the biodegradable material is a naturally occurring, compostable material.

Particularly preferably, the biodegradable material consists at least partially of home-compostable material.

The possibility of home composting ensures that even those seals 01 that are subjected to non-industrial recycling during their disposal exert the least possible harmful influence on the environment.

Composting, also known as rotting or decomposition, refers to the part of the nutrient cycle. In this part of the nutrient cycle, organic material is broken down by soil organisms under the influence of atmospheric oxygen. In addition to carbon dioxide, water-soluble minerals are also released, which act as fertilizer. Part of the intermediate products produced during this decomposition is converted into humus.

The biodegradable material can be, for example:
a biodegradable plastic, and/or
a biodegradable and bio-based plastic, and/or
a solid material of polylactic acid, and/or
cellulose, and/or
cellulose esters, and/or
celluloid, and/or

The biodegradable material can alternatively or additionally be based on the mentioned variants. Alternatively or additionally, the biodegradable material can include the mentioned variants.

Advantageously, for all described designs, the seal body 02, hereinafter also briefly referred to as the base, can be made entirely or partially of a waterproof cellulose-based material.

Alternatively or additionally, the base or parts of it can be made of waterproof paper or cardboard.

It is also important to emphasize that the term seal band 03 includes a strand-shaped element with a greatest extension along the strand. The strand-shaped element can be formed with any geometry of its cross-section perpendicular to the extension of the strand. In this context, the term band neither restricts the cross-section to a flat geometry nor to a circular geometry. In the case of a flat geometry, the band would be most accurately described as a strip. In the case of a circular geometry, the band would be most accurately described as a rope or cord or wire. For the present seal 01, both the mentioned geometries and geometries of the cross-section of the strand-shaped element lying between them can be used. The seal band 03 can be designed to be flexurally limp, flexurally elastic, flexurally soft or flexurally rigid, without limiting the basic usability of the seal 01. In the present document, the term seal band therefore stands for a flexible closure element of any cross-sectional shape. The seal band as a flexible closure element preferably has a signifi-cantly greater extension in one longitudinal direction than perpendicular to it. The term seal band is by no means limited to a specific cross-sectional shape. This can of course be flat, as is predominantly the case with a band, but also round, as is com-mon with a rope or cord or wire. But also another cross-sectional shape, for example elliptical, a hollow profile shape or a flat symmetrical or asymmetrical cross-sectional shape is possible, for example based on an asymmetrical or symmetrical aerody-namic profile, such as an airfoil profile. Basically, any cross-sectional shape is suita-ble that can be expected to realize a low bending stiffness along the longitudinal extension of the seal band or even a flexurally limp seal band or alternatively or additionally a flexurally soft seal band.

The seal 01 can alternatively or additionally have individual or a combination of several features described in the introduction in connection with the state of the art and/or in one or more of the documents mentioned in relation to the state of the art and/or in the preceding description of the embodiments shown in the drawings.

The seal 01 can, for example, find generally known use for sealing con-tainers or devices, for example on their housings, for example as customs seals in international goods and freight traffic.

For example, by attaching the seal 01 to the closure of a container or device, referred to as sealing, it can be determined whether a container or device has been opened without authorization after sealing. The same applies to other uses of the seal 01, for example as proof that a setting made on a device has not been changed, as a substitute for admission tickets, to render technical connections unusable without deactivating them, as well as for military facilities.

The invention is not limited by the description of the exemplary embodiments. Rather, the invention encompasses any new feature as well as any combination of features, which particularly includes any combination of features in the claims, even if this feature or combination itself is not explicitly stated in the claims or exemplary embodiments.

The invention is particularly commercially applicable in the field of manufacturing customs seals and the like.

Furthermore, the invention is commercially applicable in the field of manufacturing and operating systems and devices where unauthorized changes to a setting or unauthorized access must be detectable afterwards by the breaking of a seal.

The invention has been described with reference to preferred embodiments. However, it is conceivable for a person skilled in the art that modifications or changes to the invention can be made without departing from the scope of protection of the following claims.

### LIST OF REFERENCE SIGNS

01 Seal
02 Seal body
03 Seal band
04 Predetermined breaking point
05 Seal core
06 Seal jacket
07 Security flap/Security label
08 Flap protector/Label protector
21 Portion
22 Portion
23 Adhesive layer
41 Perforation line
42 Perforation line
43 Half-cut
50 Securing element
51 Fold line
52 Base part
53 Anchor part
54 Notch
55 Remaining seal core part
56 Separation line
57 Groove
60 Connecting flap (of the seal jacket halves)
61 Half (of the seal jacket)
62 Half (of the seal jacket)
70 Indicator

1. Seal (01) with a seal body (02) and a seal band (03), wherein:
the seal body (02) comprises a seal jacket (06) with two seal jacket halves (61, 62) movably connected to each other along a connecting flap (60) in an initial state, and a seal core (05),
the seal jacket halves (61, 62) can be irreversibly sealably connected at least to each other to transfer to an operational state,
at least one of the seal jacket halves (61, 62) is provided with an adhesive layer intended to create the seal,
in the initial state, one seal jacket half (61, 62) of the seal body (02) is provided with a seal core (05), which is housed between the irreversibly sealed connected seal jacket halves (61, 62) of the seal body (02) in the operational state,
in the initial state, a first section of the seal band (03) is fixed at least partially between the seal core (05) and the seal jacket half (61, 62) of the seal body (02) provided with it,
the seal core (05) has a securing element (50) for at least one second section of the seal band (03), and
the securing element (50) of the seal core (05) has an anchor part (53) pivotally connected to a base part (52) along a fold line (51) in the initial state,
characterized in that the anchor part (53) of the securing element (50) is surrounded on multiple sides by a remaining seal core part (55) of the seal core (50), of which remaining seal core part (55), however, only a part is connected to the anchor part (53) via the fold line (51).

2. Seal according to claim 1, wherein the first section of the seal band (03) is fixed between the seal core (05) and the seal jacket half (61, 62) provided with it, guided through a groove (57) formed in the seal core (05).

3. Seal according to claim 1 or 2, wherein a remaining part of the seal core (05, 52, 55) spans a plane, within which plane the anchor part (53) is completely or partially surrounded by the remaining part of the seal core (05, 52, 55).

4. Seal according to claim 1, 2 or 3, wherein in the initial state at least the remaining seal core part (55) and/or the base part (51) is connected, in particular glued, to a seal jacket half (61, 62).

5. Seal according to one of claims 1 to 4, wherein the fold line (51) is realized by a half-cut (43).

6. Seal according to one of the preceding claims, wherein the anchor part (53) borders the fold line (51) on one side.

7. Seal according to claim 6, wherein the anchor part (53) is separated from the remaining seal core part (55) on its other sides by a separation line (56).

8. Seal according to claim 7, wherein the separation line (56) converges in a V-shape towards the fold line (51).

9. Seal according to one of the preceding claims, wherein a notch (54) is provided adjacent to the anchor part (53).

10. Seal according to one of the preceding claims, wherein the remaining seal core part (55) is fixed to a seal jacket half (61, 62) provided with the seal core at least in the initial state, whereas the anchor part (53) remains pivotable out of the plane spanned by the remaining seal core part (55) around the fold line (51) in the initial state.

11. Seal according to one of the preceding claims, wherein the seal body (02) is provided with predetermined breaking points (04) that indicate an attempt to detach the seal band (03) from the seal body (02) by tearing.

12. Seal according to claim 11, wherein the predetermined breaking points 04 comprise one or more perforation lines (41, 42) in the seal jacket (06).

13. Seal according to claim 12, wherein at least one perforation line (41, 42) extends along an extension of the course of the section of the seal band (03) wrapped around the anchor part (53) to create the operational state within the seal jacket (06).

14. Seal according to claim 12 or 13, wherein the perforation lines (41, 42) are arranged mirror-symmetrically to the connecting flap (60) on the two seal jacket halves (61, 62).

15. Seal according to claim 15, wherein the fold line (51) is also arranged congruently with the perforation lines (41, 42) in the operational state.
